(19) United States
(12) Patent Application Publication
(10) Pub. No.: US 2018/0012276 A1
(43) Pub. Date: Jan. 11, 2018

(54) SYSTEMS AND METHODS FOR IDENTIFYING MEDIA AND PROVIDING SUPPLEMENTAL MEDIA INFORMATION

(71) Applicant: Adease Media Research Services Inc., Toronto (CA)

(72) Inventor: Herman Campbell, Ajax (CA)

(21) Appl. No.: 15/646,453

(22) Filed: Jul. 11, 2017

(30) Foreign Application Priority Data
Jul. 11, 2016 (CA) 2935656

(51) Int. Cl. G06Q 30/06; G06Q 30/02

(52) U.S. Cl. CPC G06Q 30/0623; G06Q 30/0255; G06Q 30/0267; G06Q 30/0261

(57) ABSTRACT

Systems and methods are provided for dynamically engaging a user with media, and providing the user with supplemental information about products or services appearing in or associated with the media. In one embodiment of the invention, sample media data is received from a media source, such as live TV or a television or radio commercial, the sample media is identified by comparing the sample media to previously identified media stored in a database, and supplemental media information, such as product placement information, is provided to the user via a network.

### FIELD OF THE INVENTION

The present invention relates to systems and methods for engaging users with media content. More specifically, the present invention provides systems and methods for identifying sample media and providing supplemental media and product information about the sample media.

### BACKGROUND OF THE INVENTION

Devices such as smart phones, tablets, and wearable devices are becoming increasingly prevalent in the modern world. These devices and applications associated with them are being used for a variety of purposes. With the ever-increasing popularity of these “smart” devices, businesses are presented with an opportunity to make use of these devices to provide a platform on which consumers can engage and interact with commercial media in a way that drives consumers to purchase goods and services.

Retail consumers are currently limited in their ability to obtain additional or supplemental information about commercial media to which they are exposed. For example, if a consumer is watching a movie and notices a retail product in which they are interested, such as a pair of shoes or fashionable purse, the consumer may conduct a search using an internet search engine to attempt to obtain more information about that product. However, due to limitations inherent in a consumer using the Internet to manually search for such information, the consumer may fail to obtain relevant information that could enable them to know more about that specific product.

Additionally, current technologies limit a retail consumer's ability to allow retail outlets to use proximity-based technologies to notify them about products they may be interested in purchasing, but that the consumer is not aware is being sold in a particular retail outlet.

### SUMMARY OF THE INVENTION

The present invention seeks to overcome some of the limitations of current advertising and media technologies, and provide a platform for users to engage and interact with commercial and non-commercial media.

The present invention provides systems and methods for identifying sample media and product information and for providing and receiving supplemental media information about the sample media.

According to one embodiment of the present invention, a user's device is used to receive sample media from a media source, such as a radio broadcast or television broadcast. The sample media data is converted into a digital hash, such as a digital audio fingerprint associated with the sample media. Using a computing device and a network, the digital hash is compared to previously identified media stored in a database to identify the sample media. Once the sample media is identified, supplemental media information about the sample media is retrieved and provided to the user. The supplemental media information may be, for example, product placement information relating to the products appearing in a television commercial at a particular instance. The supplemental media information may also include information detailing where a user can purchase identified products, or information about sales relating to those products.

According to another embodiment of the present invention, the user's device converts a visual image of captured media to a digital hash by separating the visual image into parsed visual elements, and comparing the parsed visual elements to known visual elements stored in a database. Once the parsed visual elements are identified, the invention provides supplemental media information associated with those visual elements to the user, in substantially the same manner as described above. Specifically, content owners will submit their print materials to a database, and a digital fingerprint or digital hash associated with the material will be created. The digital fingerprints or digital hashes received from a user device that has sampled the print material can then be compared to the stored digital fingerprints or digital hashes saved on the database.

In yet another embodiment of the present invention, the user is able to select certain products or services about which they wish to later receive further information. These products or services could be stored in a favorites list tied to the identity of the user. When the user is near a background positioning and detection device, such as a device typically associated with beacon technology, advertising information about the products stored in the user's favorites list can be delivered to the user's device. This ensures that a user is aware of the relevant products available or advertised around them.

In a further embodiment of the present invention, a user's device is used to receive a portion of the sample media, such that the portion begins at a first time point and ends at a second time point. The portion of the sample media is identified in substantially the same manner as described with reference to the other embodiments of this invention. Supplemental media information is then provided to a user's device, wherein the supplemental media information may include product information for products and services not appearing within the sampled portion of the sample media, but appearing at a later time point in the same sample media. This allows users to obtain supplemental media information about the entirety of an identified piece of media, as opposed to supplemental media information about only a portion of the media. This embodiment may optionally include location details about the supplemental media information, such as the time at which certain products appear in the identified media, or locations of stores at which particular products may be purchased.

### BRIEF DESCRIPTION OF THE DRAWINGS

FIG. 1 depicts an exemplary method of identifying sample media data according to one embodiment of the present invention.

FIG. 2 is an illustration of a user interface and supplemental product information appearing on a user's device according to another embodiment of the present invention.

FIG. 3 is flow chart illustrating a method of using beacon signals in retail stores to provide supplemental media information to a user according to a further embodiment of the invention.

### DETAILED DESCRIPTION OF THE INVENTION

In the drawings and description that follows, specific embodiments of the present invention are described in detailed and are shown in the drawings with the understanding that the present disclosure is an exemplification of the principles of the invention, and is not intended to limit the invention to what is illustrated and described herein. For example, certain method steps described herein may be performed in a different order to achieve the same result, as will be understood by a skilled artisan.

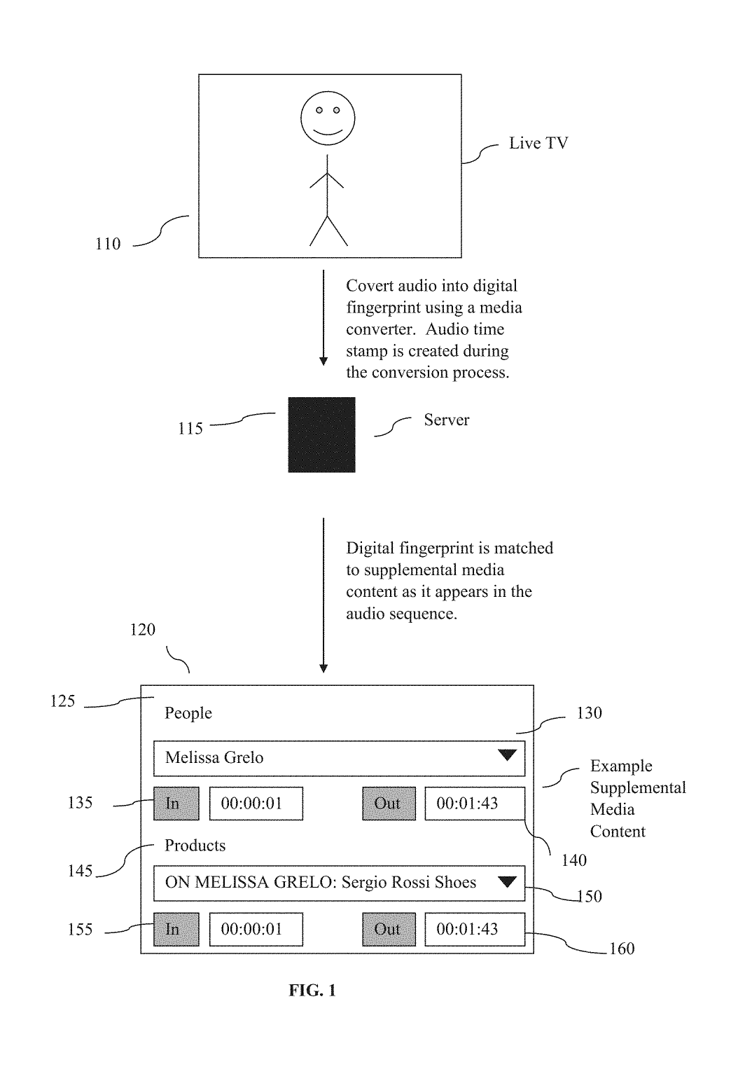

The diagram in FIG. 1 illustrates an exemplary method of identifying sample media data according to one embodiment of the present invention. According to this embodiment, a device is used to receive sample media data from, for example, live television 110. The device receives an audio clip, preferably through the device's microphone, from the television show 110 and calculates a digital hash of the audio clip, or a portion thereof, such as a digital audio fingerprint. Reception of an audio clip may be done, for example, by a smartphone receiving and digitizing sound generated by the speakers of the television set displaying the television show 110. A digital hash is the value of a hash function computed on the sampled audio data or a portion thereof. Optionally, an audio time stamp may be created and associated with the digital hash.

The television show can then be identified by comparing the digital hash to the digital hashes of previously identified media stored in a database accessible by a server 115. In certain embodiments, the database is a remote server 115 accessible via a computer network or the Internet.

According to one embodiment of the invention, in a first phase, the received audio clip, or a portion thereof, is converted to a monophonic audio clip processed using a low-pass filter to limit the frequency range to relatively low frequencies. A short-time Fourier transform (STFT) is performed on the monophonic audio clip. The STFT determines the sinusoidal frequency and phase content of local sections of the audio as it changes over time. Normalization operations are then performed to produce a volume-independent signal. The stream of local sections comprises the audio signature or digital hash. The audio signature is stored in the database and used to compare audio signatures received from user devices. In order to compare two audio signatures, a basic statistical analysis or similar analytical process can be used to identify audio sections considered to be identical.

Once the television show is identified, the server 115, or a computing device associated with the server 115, can retrieve supplemental media information 120 about the television show 110 or about the specific portion of the television show 110 captured in the digital hash or portions of the television show near in time to the hashed portion. The supplemental media information 120 may be, for example, product information about any of the products 145 appearing on screen at the time the audio clip was recorded, or within a certain amount of time before and/or after the clip, such as for one minute before the start of the clip. In certain embodiments of the invention, the supplemental media information 120 also includes information about products 145 not appearing on screen at the time the audio clip was recorded, but rather that appear at a later time in the television show. For example, if a user captures a one second audio clip during the first minute of the television show, the invention can return detailed information about products 145 appearing throughout the entire duration of the television show 110, not only about products 145 appearing in the one second clip.

Additionally, a time stamp 155, 160 associated with the products 145 may be included to make the user aware of the particular times at which specific products 150 appear in 155 the television show and the time 160 at which the specific products 150 stop appearing in the television show 110. This allows the user to find the time points 155, 160 at which the specific product 150, such as a particular make of shoes, appears so they are able to visualize the product 150 as it appears in the television show.

The supplemental media information 120 may also include information about people 125, 130 appearing in the television show 110. Similarly, the supplemental media information 120 may include a time stamp 135, 140 associated with the person 130 to make the user aware of the particular times at which a specific person 130 appears in 135 the television show and the time 140 at which the specific person 130 stops appearing in the television show 110.

In certain embodiments of the present invention, the supplemental media content 120 may include drop-down menus for the user to select a specific person 130 or specific product 150 appearing in the show 110 about which the user desires additional information.

While the example above refers to a television show 110, and several of the examples throughout this document may refer to a specific type of media, the invention can apply to other forms of media, including print advertising material, audio advertising material, visual advertising material, posters, videos, billboards, films, pamphlets, business cards, magazines, newspapers, storefront signage or radio broadcasts.

According to certain embodiments of the present invention, a visual image of captured media is converted to a digital hash by separating the visual image into parsed visual elements, and comparing the parsed visual elements to known visual elements stored in a database. Once the parsed visual elements are identified, the invention provides supplemental media information associated with those visual elements to the user, in substantially the same manner as described above. Content owners will submit their print materials to a database, and a digital fingerprint or digital hash associated with the material will be created. The digital fingerprints or digital hashes received can then be compared to the stored digital fingerprints or digital hashes saved on the database.

Additionally, while the examples described herein refer to certain supplemental media or supplemental product information being returned to the user, the supplemental information provided to the user can vary depending on the nature of the media sampled. For example, if a movie or film is sampled, the invention may return information including actor biographies, websites associated with the film, or show times for theaters in the area showing the film.

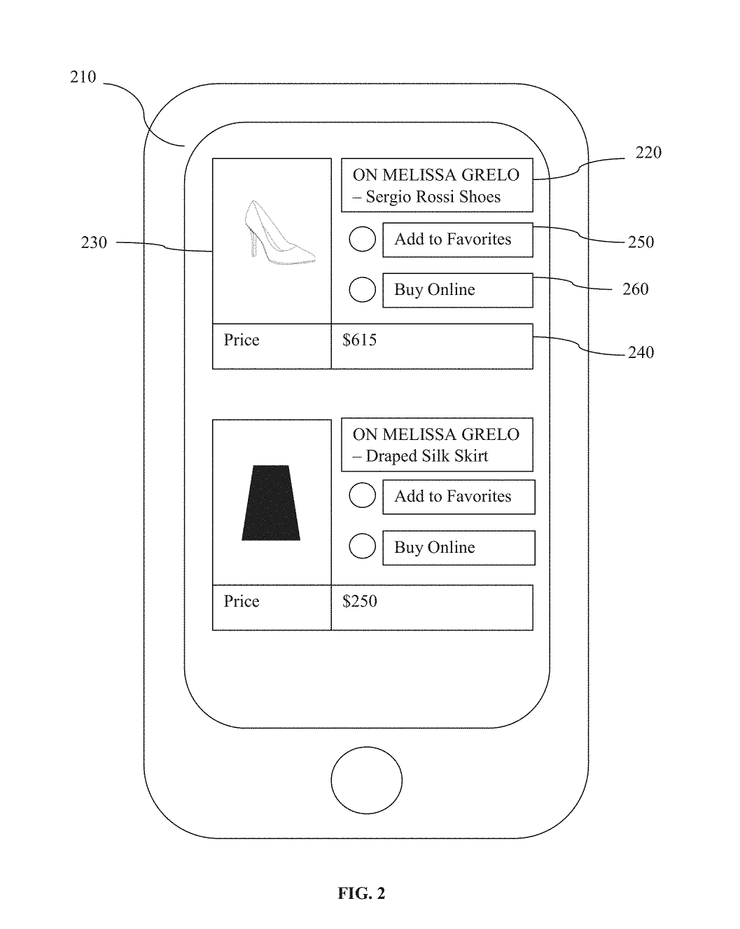

FIG. 2 is an illustration of a user interface 210, for example on a smartphone, and supplemental product information appearing on a user's device according to another embodiment of the present invention. In the example user interface shown in FIG. 2, consumer products 230 are displayed on the user's device. The supplemental product information includes a description of the product 220, a picture of the product 230, the price of the product 240 and a hyperlink 260 to a website where the product can be purchased. The description of the product 220 may include information about the person who is wearing the product in the television show.

Additionally, the user interface shown in FIG. 2 includes a mechanism 250 by which a user can add a particular product to a favorites list controlled by the user and linked to the user's preferences and identity. In this embodiment, the mechanism 250 is an on-screen option that the user may select via a touch screen interface. This allows the user to compile a list of products about which they may wish to obtain additional information in the future. The favorites list may be stored on the user's device and/or in cloud storage where it is accessible by other devices used by the user.

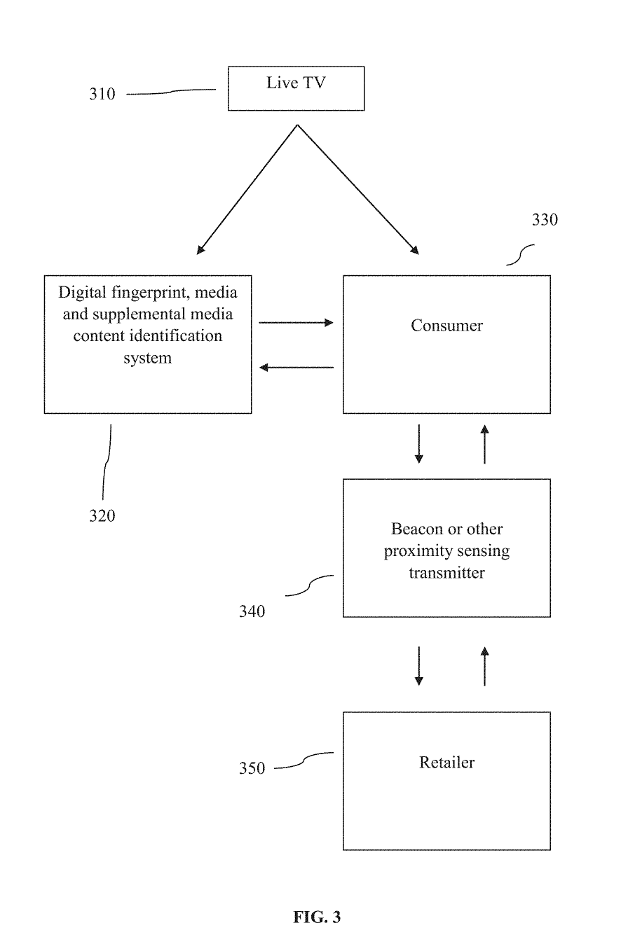

FIG. 3 is an illustration of a system and method according to yet another embodiment of the present invention that involves the use of beacon signals in retail stores to provide supplemental media information to a user. According to this embodiment of the invention, sample media is identified in substantially the same manner as described above from a media source, such as live television 310, and one or more digital fingerprints or digital hashes associated with the sampled media are created 320. As previously described, the sample media is received by a database that identifies the sample media 320. The supplemental media information can be stored in computer-readable memory and associated with the user's preferences or identity. Optionally, the desired products may be stored by the user in their favorites list.

When a user 330 who has identified products stored in association with their device or identity, for example by adding products to their favorites list, enters the proximity of a retail store 350 offering such a product for sale, or that otherwise advertises or promotes the product, beacon technology 340 can be used to inform the user 330 that additional information about one of their desired products is available.

Beacon technology, as will be understood by a person skilled in the art, includes a class of Bluetooth low energy devices that broadcast their identifier to nearby portable electronic devices. Other current or future beacon technologies may also be suitable for the same purpose. This allows devices within a certain proximity of the beacon to engage with the beacon. Beacon technology has a number of applications. For the purposes of the present invention, beacon technology, inter alia, provides for the ability to provide relevant proximity-based advertising or media information to a user, based on a user-selected list of products, user preferences, and/or a user's identity.

As will be understood by a skilled person, the described embodiments of the invention can also optionally be used for restaurants by providing the user with a copy of the menu, information about specials, or other information the restaurant wishes to share with users.

While specific embodiments of the present invention have been described herein, a person skilled in the art will understand that further embodiments are also within the scope of the invention that have not been elaborately described. For example, while the supplemental media information returned to a user's device may include products tagged with a specific time point associated with the appearance or reference to that product in the sample media, the supplemental media information or products may also be tagged with other types of tags. For example, the supplemental media information may include, without limitation, tags that identify: (1) related or similar products; (2) additional products from the same manufacturer, producer or service provider; (3) retail stores or online merchandise purveyors offering sales or discounts for the product; or (4) other information about the product as it appears in the identified media.

According to yet another aspect of the present invention, the system and method described herein may also be used to deliver coupons or other types of discounts for products. For example, if a user chooses to place a particular product on his or her favorites list, coupons or discounts for that product or related products may be provided to the user via a computing device and a network.

The methods and systems of the invention may also optionally include a mechanism for users to send electronic messages, including e-mails or social media messages, about any of the supplemental media information received by their device or about any products appearing on their favorites list. This mechanism can also allow users to share advertising information they receive about products to their social networks.

In certain embodiments of the invention, the database used to retrieve supplemental media content is a database functioning as a content management system that allows content owners to contribute their own content, providing them with an effective advertising platform. This enables the invention to provide users with a wide variety of content and advertising from all types of content contributors. Content owners contribute their content to the database, and the provided content is converted into one or more unique digital fingerprints used to identify media when sampled by a user. This evolving content management system can be amended by the content owners at any time, allowing them to make real time adjustments to what is advertised and delivered.

The present invention also allows for content owners to gather information about the users sampling their media or otherwise demonstrating interest in the products. For example, if a user samples a content owner's media, information about that user can be provided to the content owner to enable the content owner to more effectively advertise or provide desirable information to that user.

In a further embodiment of the present invention, users are able to connect with other users in association with a specific media or tag. This aspect of the invention socially engages users over the Internet and allows users to discuss or provide feedback about media or tags in which they are interested. For example, if a user captures a sample of a television show, and the system described above identifies the television show and provides supplemental media content associated with the television show, the user can use the present invention to access comments and feedback provided by other users who had previously sampled, identified and received supplemental media content for the same television show.

According to this embodiment of the invention, when any media is tagged in the database by owners, a tile associated with each tag is generated and stored in the database. When a user samples media in order to identify the media and to receive supplemental media content, they will also receive the tile associated with the sampled media and the tags. The tile allows the user to post comments or feedback about the identified media or tags, and to view comments or feedback associated with the media or tags provided by other users.

Any comments or feedback associated with a tile is stored in the database, such that any future user who receives the tile also receives access to previously contributed user comments or feedback. The tiles can also provide the users with an instant messaging platform for users to discuss or provide comments or feedback about sampled media or identified supplemental media content.

This aspect of the invention may also make use of the beacon technology described above. For example, beacon technology may be used to identify users in attendance at a particular event. Once identified, the beacon can provide the users at the event with a tile associated with the event, allowing users to provide comments or feedback about the event, which can be accessed by any other user at the same event. The content owner also has the ability to send global messages out to the users at the event.

As will be understood by a person skilled in the art, aspects of this invention may be performed passively or automatically by a user's device without requiring any action by the user. For example, a user's device may passively receive data, for example by having the method of the invention operate as a background process on the user's device. The invention can thereby identify and store sampled media, such that the user can receive supplemental media content associated with the sampled media in the future. As an example of this aspect of the invention, a user may have their cellular phone in their pocket while driving their car and listening to the radio. By having the method of the present invention operate as a background process on the cellular phone, the media broadcasting from the radio can be sampled and identified according to the present invention without any user intervention. Once the user has finished driving, he or she may access the identified sampled media which was collected passively by his or her device. The user can then choose to receive supplement media content associated with, for example, a commercial or advertisement broadcast over the radio while the user was driving.

All of the processing described above may be performed by, for example, an application-specific integrated circuit (ASIC) custom designed to implement any embodiment of the invention. Preferably, they are implemented in the form of executable software runs on a programmable computer processor and that allows the user to install the system onto their computing device locally. The appliance may be implemented as a standalone device (like a typical internet router) with Ethernet, Bluetooth and Wi-Fi interfaces. Alternatively, the appliance may take the form of a general purpose computer system running software to implement the above described processing, where the computer system may perform other functions.

Generally, a computer, computer system, computing device, client or server, as will be well understood by a person skilled in the art, includes one or more than one computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.). Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description and figures as a whole.

What is claimed is:

1. A method for identifying media and receiving supplemental media information performed by a system comprising a computer processor, the method comprising:
receiving sample media data from a user device;
identifying the sample media data by comparing a digital hash of the sample media data with a digital hash of previously identified media data stored in a database;
retrieving supplemental media information about the sample media data; and
providing via an electronic network the supplemental media information to the user device,
wherein the supplemental media information comprises product information associated with the sample media data, including purchasing information.

2. A system for identifying media and receiving supplemental media information, the system comprising:
a computer processor;
a computer-readable memory storing computer-readable instructions executable by the computer processor that when executed by the computer processor cause the system to:
receive sample media data obtained by a user device from a media source;
identify the sample media data by comparing a digital hash of the sample media data with a digital hash of previously identified media data stored in a database;
retrieve supplemental media information about the sample media data; and
provide via an electronic network the supplemental media information to the user device,
wherein the supplemental media information comprises product information associated with the sample media data, including purchasing and sales information.

3. The method of claim 1, further comprising the steps of:
storing user-selected product information;
receiving, via a beacon signal from an advertising computing device, a retail advertisement relating to the user-selected product information;
displaying the retail advertisement on the user device.

4. The method of claim 1, wherein the sample media data is a recording of at least a portion of media received via the user's device from a media source.

5. The method of claim 4, wherein the recording of the portion of the media begins at a first time point and ends at a second time point, and wherein the supplemental media information comprises product information for products associated with a second portion of the media beginning at a third time point and ending at a fourth time point.

6. The method of claim 5, wherein the supplemental media information includes a tag to indicate the location of products associated with the media.

7. The method of claim 6, wherein the tag is a timestamp indicating at least one time point that products associated with the product information appear in the media.

8. The method of claim 1, wherein the media source comprises print advertising material, audio advertising material, visual advertising material, a poster, a video, a television commercial, a billboard, a film, a pamphlet, a business card, a magazine, a newspaper, a storefront sign or a radio broadcast.

9. The method of claim 1, wherein the user device comprises a cellular telephone, a tablet, a wearable device, or a smart telecommunications device.

10. The method of claim 1, wherein the supplemental media information includes coupons relating to the product information.

11. The method of claim 1, wherein the supplemental media information includes information, including location and contact information, about retail outlets selling or advertising products related to products associated with the sample media data.

12. The method of claim 1, further comprising the steps of:
generating a tile associated with the sample media data;
providing the tile to the user device,
wherein the tile provides a user with comments and feedback from other users, the comments and feedback are associated with the sample media data, the user can comment and provide feedback relating to the sample media data and the received supplemental media content, and wherein the comments and feedback are stored in the database.
